(19) United States
(12) Patent Application Publication
(10) Pub. No.: US 2017/0103458 A1
(43) Pub. Date: Apr. 13, 2017

(54) Derivative Contracts that Settle Based on a Virtual Currency Difficulty Factor or an Index of Virtual Currency Generation Yield

(71) Applicant: Chicago Mercantile Exchange Inc., Chicago, IL (US)

(72) Inventors: Ryan Pierce, Chicago, IL (US); Sandra Ro, London (GB); Mansoor Ahmed, Naperville, IL (US)

(21) Appl. No.: 14/881,318

(22) Filed: Oct. 13, 2015

(51) Int. Cl. G06Q 40/04; G06Q 20/06; G06Q 20/38

(52) U.S. Cl. CPC G06Q 40/04; G06Q 20/381; G06Q 20/065; G06Q 2220/00

(57) ABSTRACT

The disclosed systems and methods make derivatives contracts based on an underlying virtual currency available for trading. Certain derivatives contracts have a settlement value based on the difficulty factor associated with generating the selected virtual currency. Other disclosed derivatives contracts have a settlement value based on the expected yield that a virtual currency miner can expect to generate using a particular computer configuration. The contracts can be used, for example, by virtual currency miners to hedge certain risks associated with mining virtual currency.

### BACKGROUND

### Virtual Currencies

The U.S. Department of Treasury's Financial Crimes Enforcement Network (FinCEN) distinguishes between real and virtual currencies. FinCEN defines real currency as “the coin and paper money of the United States or of any country that [i] is designated as legal tender and that [ii] circulates and [iii] is customarily used and accepted as a medium of exchange in the country of issuance.” FinCEN defines virtual currency as “a medium of exchange that operates like a currency in some environments, but does not have all the attributes of a real currency. In particular, virtual currency does not have legal tender status in any jurisdiction.” FinCEN further defines a convertible virtual currency as virtual currency that “either has an equivalent value in real currency, or acts as a substitute for real currency.” More specifically, convertible virtual currency may be bought and sold for legal tender.

The term cryptocurrency refers to a subset of virtual currencies that utilize cryptography for security purposes. Certain cryptocurrencies use a “proof of work” methodology to issue new units of currency. Other cryptocurrencies use a proof of work methodology in combination with one or more other mechanisms to issue new units of currency. One example of a cryptocurrency is the Bitcoin virtual currency. The Bitcoin virtual currency is based on a cryptography technique in which transactions between parties on a peer-to-peer computer network are verified on a public ledger. The public ledger is also known as a block chain and is made up of a series of one or more digital blocks. Each party on the peer-to-peer network stores a copy of the block chain. When a financial transaction between parties takes place, it must be verified. New blocks are created as transactions are verified, and when new blocks are created, the block chain is updated to include the new block and, accordingly, to account for the new transaction.

Parties that generate new blocks in a Bitcoin block chain using computers on the peer-to-peer network are commonly referred to Bitcoin miners. The computers used to generate the new blocks are commonly referred to as mining computers or mining rigs. New blocks in the block chain are generated when a Bitcoin miner uses a mining computer to generate a valid cryptographic signature for the newly created block. Generating this signature is computationally expensive, as it requires generating an arbitrary number (nonce) that produces a valid SHA-1 signature.

Generally speaking, Bitcoin miners use a brute force search algorithm when attempting to generate a valid signature for a block using their mining computers. The algorithm involves attempting every possible combination of nonce (e.g., sequentially or in a random order) until the block is created. If the mining computer tries every possible nonce without producing a valid signature, the mining computer can alter certain other parameters within the block and repeat the search attempt. Although any mining computer can theoretically find a nonce that generates a valid signature on any given attempt, generally speaking, the more combination attempts that a mining computer can perform over time, the higher the likelihood that the computer will successfully generate a valid signature. Therefore, a given miner's likelihood of success can generally be predicted by the rate at which the miner's mining computer performs calculations attempting to generate a valid signature. This rate is also referred to as a mining computer's hash rate. The performed calculations are also referred to as hashing operations. The cost of mining computers generally increases as the hash rate increases.

Additionally, the Bitcoin protocol is configured so only a limited number of Bitcoin can be mined, and that on average, every 10 minutes, one out of all mining computers operating globally will generate a valid signature. More specifically, the Bitcoin protocol includes an adjustable difficulty factor which directly influences the difficulty of mining a new block. More specifically, as the difficulty factor rises, the relative difficulty of computing a valid signature and mining a new block also rises.

As mentioned above, the difficulty factor is currently configured with the target goal that the group of all Bitcoin miners operating globally will create a new block, on average, every 10 minutes. More specifically, the network adjusts the difficulty factor every 2,016 blocks based on the time it took miners on the network to create the previous 2,016 blocks. Based on an average rate of one new block being created every 10 minutes, the difficulty factor is adjusted, on average, every two weeks. The historical trend has been for an increasing number of miners using increasing computational and expensive resources to attempt to mine Bitcoin over time. Therefore, because the Bitcoin protocol is configured such that new Bitcoin are mined at a relatively constant rate, the historical trend has been for the Bitcoin difficulty factor to also increase over time.

Although generating new blocks is computationally expensive and has generally become more difficult over time, miners on the peer-to-peer network are incentivized to perform computations and to attempt to generate new blocks through the use of Bitcoin rewards. More specifically, the first miner on the peer-to-peer network to successfully generate a valid cryptographic signature for a given block may be rewarded with a designated number of Bitcoin (e.g., 25 Bitcoins plus the value of any transaction fees recorded in the created block). Because Bitcoin is a convertible virtual currency, these rewards have an equivalent value in legal tender (e.g., U.S. Dollars (“USD”)).

Given the growth rate in the number of Bitcoin miners and the winner-takes-all nature of block rewards, many Bitcoin miners choose to form mining pools in which the miners combine computational resources to attempt to generate new blocks and collect the associated rewards. By combining resources, the members of the pool have a higher collective chance of collecting a reward than an individual member would have. Mining pools use an algorithm to distribute a share of the collected rewards to all members of the pool, regardless of which pool member actually generates the new block. Over the long run, a member of a Bitcoin mining pool can generally expect to generate revenue equal to the total number of block rewards and optionally, transaction fees collected by the pool multiplied by the percentage of the miner's hash rate relative to the total hash rate of all the miners in the pool. In certain pools, a pool operator collects a portion of the rewards, thereby reducing the rewards that individual members collect, but the portion collected by the pool operator, if a portion is collected at all, is generally small.

Bitcoin mining involves certain costs associated with the mining computer hardware and mining operations. These costs include the cost of purchasing mining computers and the costs of the data center space, power, cooling, staffing, etc. required to operate the mining computers. While there is financial risk involved in mining operations, because of the potential rewards, Bitcoin miners undertake these risks hoping that the value of the mined Bitcoins will exceed the miners' costs and provide a reasonable return on investment. While the costs described above are generally known upfront, estimating income generated by a mining operation can be extremely difficult because of the uncertainty involved in predicting how many Bitcoins a given mining computer will mine over time, uncertainty in terms of how much the mined Bitcoins will be worth in terms of legal tender (e.g. USD), and uncertainty in trying to predict what the Bitcoin difficulty factor will be in the future.

### Derivatives Contracts

Derivatives contracts may take many forms including, for example, futures contracts and over-the-counter (OTC) swap contracts. A futures contract is an instrument that may be bought or sold and obligate the buyer or seller to accept or make delivery of a particular instrument on a specified future date or during a specified future period. Typically, these contracts are identified by reference to the contract month which specifies when the delivery must take place. Upon delivery, a seller makes delivery of the specified quantity and quality of instrument, and the buyer accepts such delivery in return for a cash payment in a specified legal tender. For example, a given contract may require the delivery of 5,000 bushels of soybeans for an equivalent amount of USD. Another exemplary contract may require the delivery of 125,000 Euros for an equivalent amount of USD. Certain futures contracts are cash settled. That is, these futures contracts do not culminate in the delivery of a particular item for legal tender but instead, are settled by reference to a measure of the value in a specified legal tender of the subject item and expire thereupon.

An OTC swap contract may operate in a similar manner to a futures contract. OTC swap contracts, however, are generally regulated under a different set of laws and regulations than futures contracts. In spite of the different laws and regulations, OTC swap contracts can optionally be constructed similarly to futures contracts from an economic and functional standpoint.

Derivative contracts or instruments may also be constructed in the form of securities. Examples of these securities include Exchange Traded Funds (ETFs), certificates, and warrants. Currently, upwards of 90% of all global ETF trade is conducted in the U.S., while certificates and warrants are more popular on European exchanges.

Additionally, while derivative contracts generally contemplate final settlement via delivery or cash settlement, they may be traded such that the obligation to make or take delivery is offset by a counteracting transaction before the delivery day or period is reached. That is, a party can buy a futures contract one day and sell it at any time thereafter and prior to the delivery date or period. Therefore, the original obligation is offset with actually facilitating a delivery.

Among other things, derivatives contracts allow investors to hedge risk by providing offsetting compensation in case of an undesired event. Derivatives contracts may be used, for example, to hedge the risk associated with unexpectedly rising or falling prices of utilities or farm commodities.

### Central Counterparty (CCP) Clearing Model

CCP clearing is a process by which financial transactions in a particular financial instrument (e.g., equities or fixed income instruments, futures contracts, option contracts, etc.) are processed for bookkeeping purposes and subject to a level of safeguards or sureties to ensure the financial integrity of the transactions and to provide for compensation in the event of a default or failure of an entity in the clearing process. CCP clearing is commonly used in many markets. In particular, the Dodd-Frank financial reform bill specifically requires the application of CCP clearing in many OTC swap contracts. The clearing process generally involves execution, novation, bookkeeping, and financial safeguards, each of which will be described in further detail below.

Execution is the process by which a transaction is concluded. Transactions can be executed on a bilateral basis between two counterparties or on a multi-lateral basis through a physical trading system or an electronic trading system in which multiple traders interact with each other. The orders can be intermediated by executing brokers who handle order entries or they orders may be entered directly by an end user into an electronic trading system.

After a transaction is executed, it is novated. Novation involves assigning the executed transaction to a clearing house for bookkeeping purposes and the assessment of financial safeguards. Typically, transactions are financially intermediated by clearing members of the clearing house. A clearing house will typically only interact directly with clearing members, and the clearing members interact with their customers or marketplace end users.

Bookkeeping involves records keeping for transactions conducted using CCP clearing. Generally speaking a clearing house provides these records to its clearing members. The records may include information detailing particular transactions, the offset of buy vs. sell transactions, current open and outstanding positions, and/or the monies in the form of margins or performance bonds, in the form of cash or collateral, required to support such positions. In turn, the clearing members provide this information to their customers on a granular basis.

The clearing house provides financial safeguards in the form or financial guarantees or sureties that assures clearing members of the performance of contract obligations in the event of a default or other failure in the clearing process. In turn, clearing members provide some level of financial guarantee or surety to their customers to backstop their obligations. Typically, a clearing house will collect margins or other funds from its clearing members to assure performance of contractual obligations. Additionally, a clearing house may require that clearing members agree to post additional capital upon demand when needed (e.g., if there is a risk that another clearing member might default on its obligations). By doing this, a clearing house mutualizes the default or failure risk of its clearing members by aggregating funds to apply in the event of possible defaults or failures.

### BRIEF DESCRIPTION OF THE DRAWINGS

FIG. 1 depicts an illustrative Bitcoin mining system

FIG. 2 depicts a flow diagram providing an overview of an example method for settling a contract configured to be traded via a financial computer system according to the present disclosure;

FIG. 3 depicts a flow diagram providing an overview of another example method for settling a contract configured to be traded via a financial computer system according to the present disclosure; and

FIG. 4 depicts an exemplary financial computer network system that may be used to implement aspects of the embodiments disclosed according to the present disclosure.

### DETAILED DESCRIPTION

Exemplary systems and methods as disclosed herein relate to listing and clearing contracts based on certain risks associated with virtual currency mining. The contracts can be configured for trading using financial computer systems such as, for example, computer systems associated with a futures exchange (e.g., the Chicago Mercantile Exchange, Inc.). The contracts can be used, for example, to allow virtual currency miners to hedge risks associated with a virtual currency's difficulty factor or with the expected yield of a computer performing mining operations.

More specifically, certain disclosed embodiments allow for the listing and clearing of contracts based on a difficulty factor associated with a given virtual currency. The contracts can be configured to have a value, on settlement, based on the virtual currency's difficulty factor multiplied by a conversion factor as defined in the contract. As will be described in further detail below, these embodiments provide virtual currency miners with a valuable tool they can use to hedge against the financial risks associated with a virtual currency's difficulty factor.

Other disclosed embodiments allow for the listing and clearing of contracts tied to the price of an index based on the expected yield for a computer system performing mining operations related to a virtual currency (e.g., Bitcoin mining operations). More specifically, the contracts disclosed according to these embodiments can estimate the income that a miner can expect to produce based on the operations and configuration of a selected computer system. The value of these contracts at settlement can be tied to an index value that is determined based on the estimated or actual number of virtual currency rewards granted over a designated time period. In certain embodiments, the estimated or actual transaction fees associated with all virtual currency blocks generated during a designated time period can also be accounted for. After a network has rate has been received and/or calculated, an expected yield can be calculated in order to estimate the amount of virtual currency that a virtual currency miner can expect to produce using a given mining configuration. The expected yield can then be converted to a real currency value using a known conversion factor, and this real currency value can be used to generate a settlement value for the associated contract.

While the disclosed embodiments will be discussed with respect to the Bitcoin virtual currency, it will be appreciated that the disclosed embodiments may be applicable to any virtual currency now available or later developed that incorporates a proof of work methodology as described above. Examples of these virtual currencies include, but are not limited to, Peercoin, Dogecoin, and Litecoin. Additionally, while the disclosed embodiments will be discussed with respect to mining virtual currency, it will be appreciated that the disclosed embodiments may be applicable to any method for generating virtual currency.

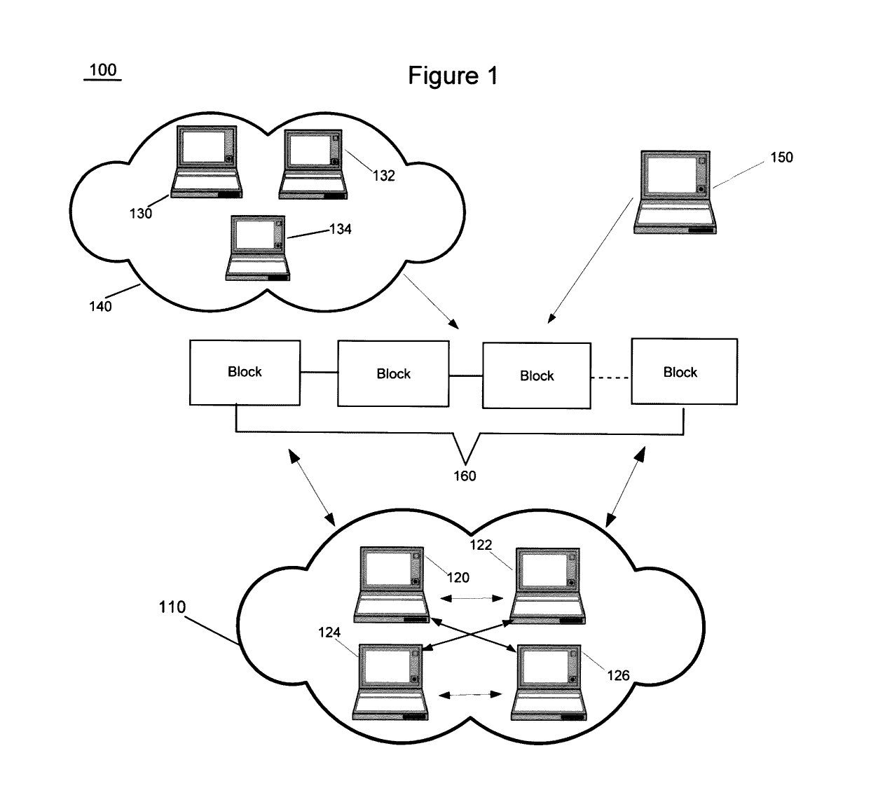

FIG. 1 depicts an illustrative Bitcoin mining system. Disclosed systems and methods can be used to generate contracts based on elements of Bitcoin mining systems such as the Bitcoin mining system 100. The Bitcoin mining system 100 depicted in FIG. 1 includes a peer-to-peer network 110 over which client computers 120, 122, 124, 126 conduct transactions. The transactions between the client computers 120, 122, 124, 126 are recorded in block chain 160. Each client computer 120, 122, 124, 126 stores a copy of the block chain 160, and as new transactions between the client computers 120, 122, 124, 126 take place, the block chain 160 is updated to record the new transactions. Each client computer 120, 122, 124, 126 in the Bitcoin mining system 100 stores a copy of the updated block chain locally.

The Bitcoin mining system 100 also includes mining computers 130, 132, 134, 150. As depicted in FIG. 1, mining computer 150 performs mining operations individually, while mining computers 130, 132, 134 combine computational resources and collectively operate as a mining pool 140. The mining computers 130, 132, 134, 150 can be configured to use a brute force search algorithm when attempting to create a new block for the block chain 160. This algorithm involves performing calculations that use every possible arbitrary number (nonce) in a random or sequential order, as well as altering other fields within the new block, to try and generate a valid cryptographic signature for a new block. The new block is created when a valid signature is found. As discussed above, the rate at which calculations are performed by a mining computer 130, 132, 134, 150 is referred to as the mining computer's hash rate.

As mentioned above, mining computers 130, 132, 134, combine computational resources and collectively operate as a mining pool 140. By combining resources, the members of the mining pool 140 have a higher collective hash rate and a higher collective chance of collecting a reward than any of the individual members 130, 132, 134 would on their own. The mining pool 140 uses an algorithm to distribute a share of the collected rewards to each of the mining computers 130, 132, 134 in the mining pool 140, regardless of which of the mining computers 130, 132, 134 actually generates the new block and initially collects the reward. Over the long run, each of the mining computers 130, 132, 134 can generally expect to generate revenue equal to the total number of block rewards and optionally, transaction fees collected by the mining pool 140 multiplied by the percentage of the individual mining computer's 130, 132, 134 hash rate relative to the total hash rate of all the mining computers 130, 132, 134 in the pool 140. An operator of the mining pool 140 can optionally collect transaction fees, and/or a portion of the collected rewards, thereby reducing the rewards that the operators of the mining computers 130, 132, 134 collect, but this portion collected by the pool operator is generally small. The expected mining yield for any of the mining computers 130, 132, 134, 150 in the mining system 100 is directly related to the difficulty factor. As discussed above, the difficulty factor is generally configured with the target goal that the group of all Bitcoin miners operating globally will create a new block, on average, every 10 minutes.

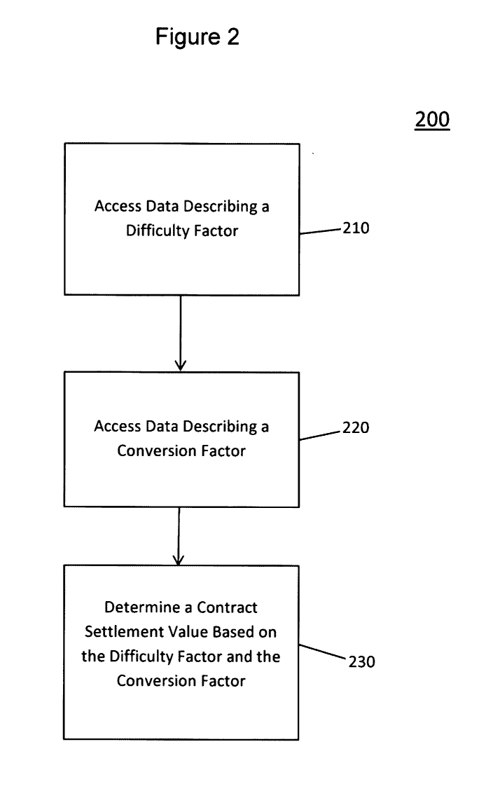

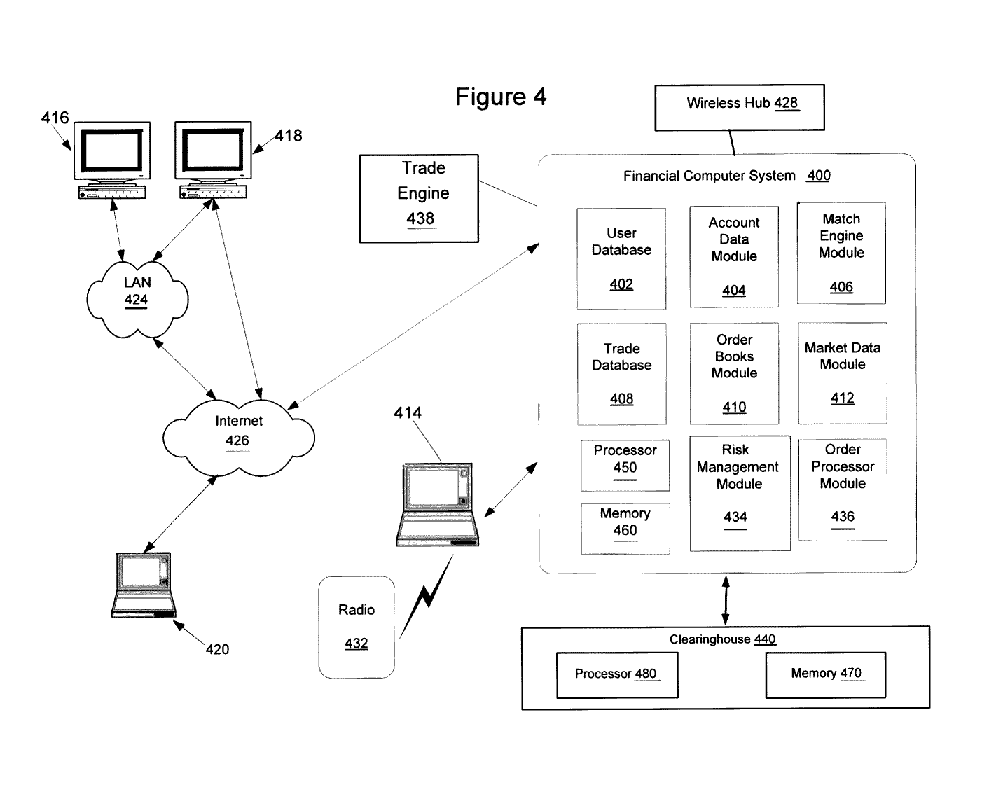

FIG. 2 depicts a flow diagram providing an overview of an example method 200 for settling a contract configured to be traded via a financial computer system according to the present disclosure. The steps depicted in FIG. 2 can be implemented, for example, using a clearing computer system, such as the clearinghouse 440 depicted in FIG. 4. The contract may be settled, for example, after being traded using a financial computer system, such as the financial computer system 400 depicted in FIG. 4. In certain embodiments, the financial computer system lists the contract, receives, and/or matches one or more orders to buy or sell the contract prior to settlement by the clearing computer system. The contract may take the form, for example, of a futures contract, an option contract, an OTC swap contract, or another financial instrument. The contract may culminate in cash settlement. While the contract remains a derivative transaction, and prior to the delivery, it is subject to a CCP clearing model.

At block 210, after a trade involving the contract has been conducted, a clearing computer system accesses data describing a difficulty factor for a virtual currency (e.g., a Bitcoin difficulty factor). As described above, according to the Bitcoin protocol, the difficulty factor is generally configured with the target goal that the group of all Bitcoin mining computers operating globally will create a new block, on average, every 10 minutes. Therefore, as the total hash rate of the global community of miners changes, the difficulty factor will adjust to maintain this average mining rate. For example, as the number of mining computers attempting to mine Bitcoin increases, the network hash rate also increases, and the difficulty factor rises accordingly. On the other hand, if the network hash rate decreases, the difficulty factor will decrease accordingly, reflecting the reduced rate at which miners are attempting to mine Bitcoin. According to the Bitcoin protocol, the Bitcoin network adjusts the difficulty factor every 2,016 blocks based on the time it took mining computers on the network to create the previous 2,016 blocks. Based on an average rate of one new block being created every 10 minutes, the difficulty factor is adjusted, on average, every two weeks.

After the trade has been conducted, the clearing computer system also accesses data describing a conversion factor associated with the virtual currency (block 220). In certain embodiments, the conversion factor can be included in the definition of the contract to be cleared and can be used to determine how much the contract will pay on settlement. For example, the conversion factor may describe a conversion rate from the received difficulty factor to a predetermined real currency (e.g., USD).

After accessing the first difficulty factor and accessing the conversion factor, the clearing computer system determines a settlement value for the contract based on the conversion factor and the difficulty factor (block 230). In certain embodiments, the settlement value is determined by multiplying the difficulty factor by the conversion factor, while in other embodiments, other operations involving the difficulty factor and the conversion factor may be performed to determine the settlement value.

Table 1 illustrates the construction of an exemplary futures contract that can be settled using the steps described with respect to FIG. 2. While Table 1 illustrates a futures contract, many other contract designs (e.g., other futures contracts, swaps, options, etc.) are possible using the disclosed systems and methods.

TABLE 1

| | |
|---|---|
| Contract Size | $0.000001 × Bitcoin Difficulty Factor |
| Minimum Price | 10,000,000 index points = $10 |
| Increment (Tick) | |
| Settlement | Cash settled as $0.000001 × the current Bitcoin |
| Process | Difficulty Factor as of 2 PM (CT) on the last business |
| | day of the contract month. |
| Contract Months | January, February, March, April, May, June, July, |
| | August, September, October, November, and |
| | December |
| Last Trading Day | 2 PM (CT) on the last business day of the contract |
| and Time | month. |
| Trading Hours | Sundays through Thursdays: 5PM-4PM (CT) next day. |

This contract allows miners of virtual currency to hedge some of the risks associated with virtual currency mining. Because the long-term growth rate of the difficulty factor is impossible to know in advance, by taking a long position in the contract, or being long a call option on the contract, a miner can lock in a projected growth rate of the difficulty factor. If the network hash rate grows faster than anticipated, the income from mining may fall, but the variation and settlement of the futures or the funds received by exercising a cash-settled call option contract would cover the loss. On the other hand, if the difficulty factor grows more slowly than anticipated or falls, the contract would lose value or the call option premium would expire as worthless, but a miner would make more money than expected on mining operations.

The contract can also be used, for example, by mining hardware manufacturers to hedge their product inventory. More specifically, as the difficulty factor rises, mining computers may become less marketable, so taking a long position in the generated contract, or being long a call option on the generated contract, would allow manufacturers to lock in a projected growth rate of the difficulty factor and hedge against the risk of falling hardware prices.

In certain embodiments, the contract can also be used in strategies involving other virtual currencies or with other related contracts. For example, the Peercoin virtual currency has the same mining hardware requirements as Bitcoin, so virtual currency miners can easily switch from mining for one currency to mining for the other currency. Because of this, there is a known relationship between the difficulty factors of the two currencies and the relative values or exchange rate of the two currencies. Based on this relationship, in certain embodiments, the contract may be used in arbitrage strategies involving the two currencies.

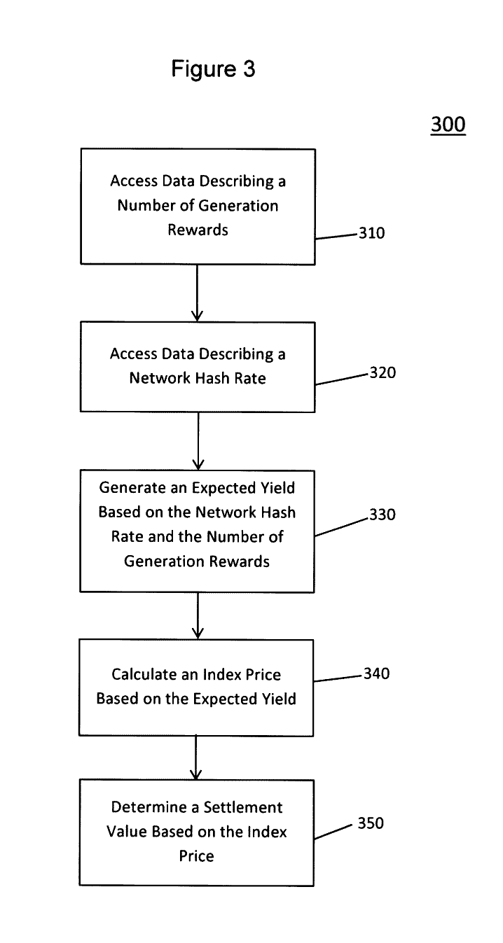

FIG. 3 depicts a flow diagram providing an overview of another example method 300 for settling a contract configured to be traded via a financial computer system according to the present disclosure. The settled contract estimates the income that a given miner can expect to produce during a designated time period using a mining computer with a designated hash rate. The steps depicted in FIG. 3 can be implemented, for example, using a clearing computer system, such as the clearinghouse 440 depicted in FIG. 4. The contract may be settled, for example, after being traded using a financial computer system, such as the financial computer system 400 depicted in FIG. 4. In certain embodiments, the financial computer system lists the contract, receives, and matches one or more orders to buy or sell the contract prior to settlement by the clearing computer. The contract may take the form, for example, of a futures contract, an option contract, an OTC swap contract, or another financial instrument. The contract may culminate in cash settlement. While the contract remains a derivative transaction, and prior to the delivery, it is subject to a CCP clearing model.

At block 310, a clearing computer system accesses data describing a number of generation rewards for a virtual currency awarded on a selected date or over a designated time period. As described above, for the Bitcoin protocol, generation rewards (e.g., mining rewards) are granted when a miner generates a valid cryptographic signature for a new block. The Bitcoin protocol is configured such that new rewards are generated every 10 minutes, and currently, miners are rewarded with 25 Bitcoin when a mining computer generates a new, valid block. In certain embodiments, the data describing the number of generation rewards can be estimated by multiplying the rate at which new blocks are generated by the rewards associated with each new block. In other embodiments, the actual number of generation awards can be calculated, for example, by examining the Bitcoin block chain to determine the actual number of new blocks generated on or over the relevant time period (e.g., on a particular date or over a designated month) and adding the generation rewards for each block. In certain embodiments, the calculated or estimated number of generation rewards may account for transaction fee rewards.

At block 320, the clearing computer system accesses data describing a network hash rate for a network of computers performing hashing operations. In one embodiment, the received hash rate can estimate the number of mining calculations (i.e., hashes) performed over the entire network of virtual currency miners worldwide. For example, a received hash rate of 193,000,000 Gigahashes/second (GH/s) estimates that 193*10¹⁵ hashing operations are being performed on the network per second. The estimated network hash rate can be based, for example, upon the difficulty factor for a designated time period or by examining the number of new blocks calculated over the designated time period (e.g., over the previous 24 hours). In certain embodiments, the hash rate may account for wasted calculations (hashes) in which a miner is performing calculations on blocks which do not receive a Bitcoin reward. The blocks which do not receive a reward may be referred to as orphaned blocks. Accounting for these calculations may cause the calculations performed by the financial computer system to converge more closely with results that actual miners would experience.

After accessing data describing the number of mining rewards for a virtual currency and data describing the hash rate over the worldwide network of miners, the clearing computer system generates a yield of the virtual currency based on the hash rate and the number of mining rewards (block 330). Generating the yield involves dividing the mining rewards over a time period by the network hash rate over that same period and multiplying this value by a nominal normalizing factor (e.g., 1 Terahash/second (“TH/s”)) to generate a yield rate describing an expected number of virtual currency rewards granted over a specified time period for a given hashing rate corresponding to that normalizing factor.

For example, in one embodiment, the data received by the clearing computer system may estimate that 3,600 Bitcoin have been awarded on a given day (24 hours/day*25 Bitcoins/reward*6 rewards/hour). Further, the estimated hash rate may be 193,000,000 GH/s. The mining rewards may be divided by the hash rate, and the resulting number may be multiplied by a normalizing factor of 1 TH/s to determine a yield rate. In this example, the yield rate is 0.01865 Bitcoin per TH/s per day ((3,600 Bitcoin/day/193,000,000*10⁹H/s)*10¹²H/s).

The clearing computer system then calculates an index price based on the calculated yield (block 340). In certain embodiments, the index may be valued based on the average yield over a designated time period (e.g., over a contract month). The index price can be tied to the value of a real currency (e.g., USD). In certain embodiments, in order to calculate the index value, the clearing computer system multiplies the yield reward rate by a known spot rate between the virtual and real currencies (e.g., $475 USD/Bitcoin). In the example above, using a spot rate of $475 USD/Bitcoin, the index price is equal to $8.86/(TH/s) per day. In other words, in this example, a Bitcoin miner could expect to earn $8.86 each day for each TH/s in mining capacity, e.g., if the Bitcoin miner has mining computers operating at 100 TH/s, the Bitcoin miner can expect to earn $886. After calculating the index price, the clearing computer system determines a settlement price based on the index price (block 350). The settlement price can be determined, for example, using the terms of the contract. For example, in an embodiment, the settlement price of the contract may be determined by multiplying the index value by a predetermined multiplier.

Table 2 illustrates the construction of an exemplary futures contract that can be settled using the method of FIG. 3. While Table 2 illustrates a futures contract, many other contract designs (e.g., other futures contracts, swaps, options, etc.) can be settled using the disclosed systems and methods.

TABLE 2

| | |
|---|---|
| Contract Size | 100 TH/s (e.g., if 1 TH/s per day has a contract price |
| | of $8.86, a contract covering 100 TH/s per day over |
| | a 30 day period is valued at $26,580 ($8.86*100 TH/s |
| | per day* 30 days.) |
| Minimum Price | $0.001 USD per TH/s or $30 (=$0.001*100 TH/s per |
| Increment (Tick) | day * 30 days) |
| Settlement | Cash settled vs. value of Index*100. The index is |
| Process | valued at the average yield over the course of the |
| | contract month. |
| Contract Months | January, February, March, April, May, June, July, |
| | August, September, October, November, and |
| | December |
| Last Trading Day | 2 PM (CT) on the last business day of the contract |
| and Time | month. |
| Trading Hours | Sundays through Thursdays: 5PM-4PM (CT) next day. |

In certain embodiments, miners can purchase contracts (e.g., contracts similar to the contract described in Table 2) based on their mining capacity in order to hedge their income based on their known hash rate. This allows miners to guarantee a certain level of income regardless of changes in the network hash rate or the difficulty factor. These contracts can also enable a miner to make purchasing decisions, protecting the miner's investment with a hedge consisting of individual contracts, one or more calendar strips of contracts, or both.

For example, in one embodiment, a miner is interested in purchasing 1,000 mining computers, each of which has a hash rate of 450 GH/s. The mining computers are available for mining on October 1^{st}, and the initial cost of purchasing and configuring each mining computer for operation is $350 USD. The cost of operating 1,000 mining computers is $30,000 USD/month. Assuming each mining computer is operating 100% of the time, the total hash rate for the group of 1,000 mining computers is 450 TH/s (450 (GH/s)/mining computer*1,000 mining computers). Assuming that each month is 30 days long, to simplify calculations, the miner's estimated operating cost per TH/s of mining resources is $2.22 per day per TH/s (($30,000 operating cost/month)/(30 days/month*450 TH/s hash rate)).

Contract bids for the mining yield in this embodiment, expressed in USD, are listed below in Table 3.

TABLE 3

| Month | Contract Bid Price |
|---|---|
| October 2014 | $10.45 |
| November 2014 | $9.35 |
| December 2014 | $8.25 |
| January 2015 | $7.15 |
| February 2015 | $6.05 |
| March 2015 | $4.95 |
| April 2015 | $3.85 |
| May 2015 | $2.75 |
| June 2015 | $1.65 |

Based on these contract bids, it does not make sense for the miner to operate these mining computers past May 2015, as his expected operating costs ($2.22 per day per TH/s) exceed the expected yield ($1.65 per day per TH/s) starting in June 2015. Therefore, in order to hedge his income, the miner can sell a strip of contracts where the quantity sold corresponds to a notional value of 450 TH/s for each month, for the months of October 2014 through May 2015. Using this strategy, the miner can expect to earn income, less monthly operating expenses as summarized in Table 4.

TABLE 4

| | Contract | | Income, less Monthly |
|---|---|---|---|
| Month | Purchase Price | Income | Operating Expenses |
| October 2014 | $10.45 | $141,075 | $111,075 |
| November 2014 | $9.35 | $126,225 | $96,225 |
| December 2014 | $8.25 | $111,375 | $81,375 |
| January 2015 | $7.15 | $96,525 | $66,525 |
| February 2015 | $6.05 | $81,675 | $51,675 |
| March 2015 | $4.95 | $66,825 | $36,825 |
| April 2015 | $3.85 | $52,975 | $22,975 |
| May 2015 | $2.75 | $37,125 | $7,125 |

In this embodiment, the miner hedges $473,800 in income, less operating expenses. The miner can spend $350,000 to purchase the mining computers and configure them for operation, operate the mining computers at a cost of $30,000 per month, and expect a hedged profit of $122,800. Because of his hedged positions, if the value of Bitcoin falls against the U.S. Dollar, the price of the contracts falls, and the short position offsets the loss of income caused by the lower value of the mined Bitcoins. On the other hand, if the difficulty factor rises faster than expected (e.g., due to newer hardware making the miner's hardware obsolete), the price of the contract falls, and the short position offsets the loss of income due to fewer Bitcoins being mined. Of course, if the value of Bitcoin rises against the dollar or the difficulty factor rises more slowly than expected, the miner may experience a loss on the contracts, but this loss will be offset by a gain in mining income.

FIG. 4 depicts an exemplary computer network system that may be used to implement various aspects of the embodiments disclosed according to the present disclosure. The computer network system of FIG. 4 is only one example of a suitable system and is not intended to suggest any limitation as to the scope of use or functionality of the various embodiments of the disclosure. Aspects of the present disclosure can be implemented with computing devices and networks for exchanging, transmitting communicating, administering, managing and facilitating trading information including, but not limited to virtual currency spot rates, network hash rates, and virtual currency difficulty factors. The financial computer system 400 can be configured to generate or receive market data, list contracts, analyze data, and calculate various values (e.g., contract parameters), and perform other operations in accordance with aspects of the disclosure.

Financial computer system 400 may be implemented with one or more mainframes, servers, gateways, controllers, desktops or other computers. The financial computer system 400 may include one or more modules, processors, databases, mainframes, desktops, notebooks, tablet PCs, handhelds, personal digital assistants, smartphones, gateways, and/or other components, such as those illustrated in FIG. 4. Moreover, the financial computer system 400 may include one or more processors (e.g., Intel® microprocessor, AMD® microprocessor, RISC processor, etc.) such as processor 450 and one or more memories (e.g., solid state, DRAM, SRAM, ROM, Flash, non-volatile memory, hard drive, registers, buffers, etc.) such as memory 460. The memory 460 may store instructions that when executed by the one or more processors 450 cause one or more of the components of the financial computer system 400 to perform computer executable methods as disclosed herein.

In addition, an electronic trade engine 438, such as the Globex® trading system, may be associated with the financial computer system 400. In certain embodiments, the electronic trade engine 438 is incorporated into the financial computer system 400, while in other embodiments, the electronic trade engine is coupled to the financial computer system 400. In certain embodiments, the electronic trade engine 438 includes a combination of globally distributed computers, controllers, servers, networks, gateways, routers, databases, memory, and other electronic data processing and routing devices. The electronic trade engine 438 may include a trading system interface having devices configured to route incoming messages to an appropriate devices associated with the trading system. The trading system interface may include computers, controllers, networks, gateways, routers and other electronic data processing and routing devices. Orders that are placed with or submitted to the financial computer system 400 can be received at the trading system interface. The trading system interface can route the order to an appropriate device. By using the electronic trade engine 438, the financial computer system 400 can receive orders and transmit market data related to orders and trades to users. These orders may include, for example, orders to buy and/or sell contracts such as those disclosed herein.

A user database 402 may include information identifying traders and other users of financial computer system 400. Such information may include user names and passwords. A trader operating an electronic device (e.g., computer devices 414, 416, 418 and 420) interacting with the financial computer system 400 may be authenticated against user names and passwords stored in the user database 402. Furthermore, an account data module 404 may process account information that may be used during trades. The account information may be specific to the particular trader (or user) of an electronic device interacting with the financial computer system 400.

A match engine module 406 may match bid and offer prices for contracts configured in accordance with aspects of the disclosure. The match engine module 406 may be implemented with software that executes one or more algorithms for matching bids and offers for bundled financial instruments in accordance with aspects of the disclosure. Like other components of the financial computer system 400, in certain embodiments, the match engine module may perform operations based on instructions from processor 450. Additionally, the match engine module 406 and trading system interface may be separate and distinct modules or components or may be unitary parts. Further, the match engine module 406 may be configured to match orders (e.g., buy and sell orders) submitted to the trading system when the orders are equal. The match engine module 406 may match orders according to currently known or later developed trade matching practices and processes. In an embodiment, bids and orders are matched on price, on a first-in-first-out (FIFO) basis. The matching algorithm also may match orders on a pro-rata basis or combination of FIFO and pro-rata basis. Other processes and/or matching processes may also be employed.

Moreover, a trade database 408 may be included to store historical information identifying trades and descriptions of trades. In particular, a trade database may store information identifying or associated with the time that an order was executed and the contract price. The trade database 408 may also comprise a storage device configured to store at least part of the orders submitted by electronic devices operated by traders (and/or other users). A confirmation message may be sent when the match engine module 406 finds a match for an order and the order is subsequently executed. The confirmation message may, in some embodiments, be an e-mail message to a trader, an electronic notification in one of various formats, or any other form of generating a notification of an order execution.

Furthermore, an order book module 410 may be included to compute or otherwise determine current bid and offer prices. The order book module 410 may be configured to calculate the price of a financial instrument.

A market data module 412 may be included to collect market data and prepare the data for transmission to users. In addition, a risk management module 434 may be included in computer system 400 to compute and determine the amount of risk associated with a financial product or portfolio of financial products. An order processor module 436 may be included to receive data associated with an order for a financial instrument. The order processor module 436 may decompose delta based and bulk order types for processing by order book module 410 and match engine module 406. The order processor module 436 may be configured to process the data associated with the orders for financial instruments.

The trading network environment shown in FIG. 4 includes computer (i.e., electronic) devices 414, 416, 418, 420 and 422. The computer devices 414, 416, 418, 420 and 422 may include one or more processors, or controllers, that control the overall operation of the computer. The computer devices 414, 416, 418, 420, and 422 may include one or more system buses that connect the processor to one or more components, such as a network card or modem. The computer devices 414, 416, 418, 420, and 422 may also include interface units and drives for reading and writing data or files. Depending on the type of computer device, a user can interact with the computer with a keyboard, pointing device, microphone, pen device or other input device. For example the electronic device may be a personal computer, laptop or handheld computer, tablet PC and like computing devices having a user interface. The electronic device may be a dedicated function device such as personal communications device, a portable or desktop telephone, a personal digital assistant (“PDA”), remote control device, personal digital media system and similar electronic devices.

Computer device 414 is shown directly connected to financial computer system 400. Financial computer system 400 and computer device 414 may be connected via a T1 line, a common local area network (LAN) or other mechanism for connecting computer devices. Computer device 414 is shown connected to a radio 432. The user of radio 432 may be a trader or exchange employee. The radio user may transmit orders or other information to a user of computer device 414. The user of computer device 414 may then transmit the trade or other information to financial computer system 400.

Computer devices 416 and 418 are coupled to a local area network (LAN) 424. LAN 424 may have one or more of the well-known LAN topologies and may use a variety of different protocols, such as Ethernet. Computers 416 and 418 may communicate with each other and other computers and devices connected to LAN 424. Computers and other devices may be connected to LAN 424 via twisted pair wires, coaxial cable, fiber optics or other media. Alternatively, a wireless personal digital assistant device may communicate with LAN 424 or the Internet 426 via radio waves. The PDA may also communicate with financial computer system 400 via a conventional wireless hub 428, As used herein, a PDA includes mobile telephones and other wireless devices that communicate with a network via radio waves.

FIG. 4 also shows 424 connected to the Internet 426. LAN 424 may include a router to connect LAN 424 to the Internet 426. Computer device 418 is shown connected directly to the Internet 426. The connection may be via a modem, DSL satellite dish or any other device for connecting a computer device to the Internet.

The operations of computer devices and systems shown in FIG. 4 may be controlled by computer-executable instructions stored on computer-readable storage medium. Embodiments also may take the form of electronic hardware, computer software, firmware, including object and/or source code, and/or combinations thereof. Embodiments may be stored on computer-readable media installed on, deployed by, resident on, invoked by and/or used by one or more data processors (e.g., risc processor), controllers, computers, clients, servers, gateways, networks of computers, and/or any combinations thereof. The computers, servers, gateways, may have one or more controllers configured to execute instructions embodied as computer software. For example, computer device 414 may include computer-executable instructions for receiving difficulty factor data and other information from financial computer system 400 and displaying this information to a user. In another example, computer device 418 may include computer-executable instructions for receiving market data from financial computer system 400 and displaying that information to a user. In yet another example, a processor of financial computer system 400 may be configured to execute computer-executable instructions that cause the financial computer system 400 to calculate a performance bond amount required to balance risk associated with a portfolio.

One or more market makers may make and/or maintain a market by providing bid and offer prices for a derivative or security to financial computer system 400. The financial computer system 400 may also exchange information with other trade engines, such as trade engine 438. One skilled in the art will appreciate that numerous additional computers and systems may be coupled to the financial computer system 400. In certain embodiments, these additional computers and systems may be incorporated into the financial computer system 400. Such computers and systems may include clearing, regulatory and fee systems, such as clearinghouse 440, Coupling can be direct as described or any other method described herein.

The clearinghouse 440 enables the financial computer system 400 to provide contracts with a lower likelihood of default than OTC products. More specifically, the clearinghouse 440 arranges for transactions to be settled and cleared. In certain embodiments, clearinghouse 440 may be configured to settle and/or clear transactions using the methods described herein. In certain embodiments, the clearinghouse 440 performs operations based on instructions stored on memory 460 and executed by processor 450. In other embodiments, the clearinghouse 440 can perform operations based on instructions stored on locally stored memory 470 and executed by local processor 480.

Clearing is the procedure through which the clearinghouse 440 becomes buyer to each seller of a contract (e.g., futures contract, equities, currencies, interest rate products, etc.), and setter to each buyer, and assumes responsibility for protecting buyer and seller from financial loss by assuring performance on each contract. A clearinghouse 440 may settle trading accounts, clear trades, collect and maintain performance bond funds, regulate delivery and report trading data. In some scenarios an exchange may operate its own clearinghouse 440 through a division of the exchange through which all trades made are confirmed, matched, and settled each day until offset or delivered. Alternatively, one or more other companies may be provided the responsibility of acting as a clearinghouse 440 with the financial computer system 400 (and possibly other financial computer systems). The financial computer system 400 may be associated with one or more clearinghouses 440. Additionally, the financial computer system 400 may offer firms qualified to clear trades to provide a clearinghouse 440 for the financial computer system 400. In some instances, these clearing members may be designated into different categories based on the type of commodities they can clear and other factors.

The clearinghouse 440 may establish minimum performance bond (i.e., margin) requirements for the products it handles. A customer may be required to deposit a performance bond with the clearinghouse 440 (or designated account) for the purpose of insuring the clearinghouse 440 against loss on open positions. The performance bond helps ensure the financial integrity of brokers, clearinghouses, and exchanges as a whole. If a trader experiences a drop in funds below a minimum requirement, the clearinghouse 440 may issue a margin call requiring a deposit into the margin account to restore the trader's equity. A clearinghouse 440 may charge additional performance bond requirements at the clearinghouse's discretion. For example, if a clearinghouse's potential market exposure grows large relative to the financial resources available to support those exposures, the clearinghouse 440 may issue a margin call.

In another embodiment, the clearinghouse 440 may require a larger performance bond based on a credit check (e.g., an analysis of the credit worthiness, such as using a FICO™ or comparable score, inter alia) of the customer/trader. The credit check may be performed i.e., initiated) by a clearinghouse 440 or another system associated with the financial computer system 400. In the example where the clearinghouse 440 performs the credit check, the clearinghouse 440 may send a message (e.g., enforcement message) to the financial computer system 400. If the credit check indicates that a customer/trader is a high risk, the enforcement message may increase the margin requirements of the customer/trader, or otherwise adjust the capabilities/constraints of the customer/trader commensurate with the higher risk. In the example where the financial computer system 400 initiates the credit check, the financial computer system 400 may send a message to one or more clearinghouses associated with the financial computer system 400 to update them on the increased/decreased risk associated with the customer/trader.

The principal means by which a clearinghouse 440 mitigates the likelihood of default is through mark-to-market (MTM) adjustments. The clearinghouse 440 derives its financial stability in large part by removing debt obligations among market participants as they occur. Through daily MTM adjustments, every contract is debited or credited based on that trading session's gains or losses. For example, as prices move for or against a position, funds flow into or out of the trading account. This cash flow is known as settlement variation.

Numerous additional servers, computers, handheld devices, personal digital assistants, telephones and other devices may also be connected to financial computer system 400. Moreover, one skilled in the art will appreciate that the topology shown in FIG. 4 is merely an example and that the components shown in FIG. 4 may be connected by numerous alternative topologies.

1. A computer system comprising:
a financial computer system that includes:
an order book that determines bid and offer prices for financial instruments;
a match engine that matches bids and offers for financial instruments;
a trade database that stores trade information;
a trader computer device connected to the financial computer system and configures to allow a trader to communicate with the financial computer system;
a clearinghouse computer connected to the financial computer system and that includes:
processor;
a computer readable medium containing computer-executable instructions that when executed cause the clearing house processor to perform the steps comprising:
(a) receiving a virtual currency mining difficulty factor:
(b) receiving a conversion factor; and
(c) determining a value of a financial instrument by at least in part multiplying the conversion factor by the virtual currency mining difficulty factor.

2. The system of claim 1, wherein the financial instrument comprises a futures contract.

3. The system of claim 1, wherein the financial instrument comprises a cash settled futures contract.

4. The system of claim 1, wherein the value of the financial instrument in (c) comprises a cash settlement value of the futures contract.

5. The system of claim 1, wherein the virtual currency is a cryptocurrency.

6. The system of claim 1, wherein the difficulty factor is adjustable and changes over time.

7. The system of claim 6, wherein the difficulty factor changes as more virtual currency is mined.

8. The system of claim 1, further including:
a financial computer system in communication with the clearinghouse processor and that includes a match engine module that matches orders for the financial instrument.

9. The system of claim 8, wherein the financial computer system further comprises an order book module that determines current bids and offers for the financial instrument.

10. The system of claim 8, wherein the financial computer system further comprises a market data module that collects and transmits market data.

11. A method comprising:
(a) receiving with a processor a virtual currency mining difficulty factor:
(b) receiving with a processor a conversion factor; and
(c) determining a value of a financial instrument by at least in part multiplying the conversion factor by the virtual currency mining difficulty factor.

12. The method of claim 11, wherein the financial instrument comprises a cash settled futures contract.

13. The method of claim 12, wherein the value of the financial instrument in (c) comprises a cash settlement value of the futures contract.

14. The method of claim 11, wherein the virtual currency is a cryptocurrency.

15. The method of claim 11, wherein the difficulty factor is adjustable and changes over time.

16. A method comprising:
receiving at a processor a virtual currency reward value for rewards provided to miners of a virtual currency during a reward period;
receiving at a processor a network hash rate for computers performing virtual currency mining during the reward period;
determining with a processor a yield rate of the virtual currency based on the network hash rate and the reward value; and
determining at a processor an index price based on the yield rate of the virtual currency.

17. The method of claim 16, further including:
determining with a processor a cash settlement value of a financial instrument based on the index price.

18. The method of claim 17, wherein the financial instrument comprises a futures contract.

19. The method of claim 17, wherein the yield rate comprises dividing the reward value by the network hash rate and multiplying by a conversion factor.

20. The method of claim 17, wherein the virtual currency is a cryptocurrency.

21. The method of claim 17, wherein the network hash rate is determined by inference from the difficulty factor.

22. The method of claim 17, wherein the network hash rate is determined by observation of a block chain, including the time taken to mine blocks, and a difficulty factor.

23. The method of claim 17, wherein the virtual currency reward is estimated based on the difficulty factor, the average time to mine a block, and the schedule of reward issuance as determined by the cryptocurrency protocol.

24. The method of claim 17, wherein the virtual currency reward is observed over a reward period by examining a block chain.

25. The method of claim 17, wherein the virtual currency reward includes transaction fees.

26. The method of claim 17, wherein the virtual currency reward is adjusted to account for mining lost due to orphaned blocks.
